(19) United States
(12) Patent Application Publication
(10) Pub. No.: US 2026/0113746 A1
(43) Pub. Date: Apr. 23, 2026

(54) DEMODULATION REFERENCE SIGNAL-BASED CONTROL INFORMATION SIGNALING

(71) Applicant: QUALCOMM Incorporated, San Diego, CA (US)

(72) Inventors: Weimin DUAN, San Diego, CA (US); Jing LEI, San Diego, CA (US); Kangqi LIU, San Diego, CA (US)

(21) Appl. No.: 18/922,100

(22) Filed: Oct. 21, 2024

(51) Int. Cl. H04W 72/1273; H04W 72/232

(52) U.S. Cl. CPC H04W 72/1273; H04W 72/232

(57) ABSTRACT

Methods, systems, and devices for wireless communications are described. A user equipment (UE) may use one or more parameters associated with a demodulation reference signal (DMRS) to identify control information intended for the UE. As an example, a DMRS associated with a physical downlink control channel (PDCCH) may be transmitted to the UE, and one or more parameters (such as a frequency-domain location of the DMRS, a time-domain location of the DMRS, a comb offset of the DMRS, a density of the DMRS, or the like) may indicate control information to the UE. In some examples, the control information may be used by the UE to perform one or more operations, such as for PDCCH monitoring, low-power operations, or the like. In any case, the control information indicated via the DMRS parameters may be separate from and/or in addition to control information carried via, for example, downlink control information (DCI).

### FIELD OF TECHNOLOGY

The following relates to wireless communications, including demodulation reference signal (DMRS)-based control information signaling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A user equipment (UE) may receive control information from a network entity via a physical downlink control channel (PDCCH). For example, the PDCCH may be used to carry downlink control information (DCI) associated with one or multiple users, and each UE may decode the DCI that is intended for that UE. To reduce power consumption and overhead at the UE, a relatively limited set of control channel element (CCE) locations may be specified for detecting DCI. A UE may attempt to decode DCI by performing a process known as a blind decode, during which search spaces may be randomly decoded until the DCI is detected. Blind decoding, however, may result in a significant amount of power consumed by the UE. Thus, techniques may be implemented to reduce the amount of blind decoding that a UE performs when monitoring for PDCCH.

In some cases, it may be desirable to enable a UE to detect control information relevant to the UE prior to decoding the DCI, which may enable various techniques for reducing blind decoding and improve resource utilization in a system. As an example, one or more parameters associated with a demodulation reference signal (DMRS) for the PDCCH may be used to indicate control information to the UE. In such cases, the one or more DMRS parameters may carry control information (e.g., separate from and/or in addition to control information carried via DCI) that the UE may quickly and efficiently detect for performing one or more operations (e.g., PDCCH monitoring, low-power reception, among other examples). Such control information indicated via the one or more DMRS parameters may enable an indication of control parameters without detecting and decoding DCI.

A method for wireless communications by a UE is described. The method may include receiving a set of DMRSs associated with a downlink control channel, where the set of DMRSs is received in accordance with one or more parameters, and where the one or more parameters are indicative of control information for the UE, identifying the control information that is indicated by the one or more parameters of the set of DMRSs, and performing one or more operations in accordance with the control information.

A UE for wireless communications is described. The UE may include one or more memories storing processor executable code, and one or more processors coupled with the one or more memories. The one or more processors may individually or collectively be operable to execute the code to cause the UE to receive a set of DMRSs associated with a downlink control channel, where the set of DMRSs is received in accordance with one or more parameters, and where the one or more parameters are indicative of control information for the UE, identify the control information that is indicated by the one or more parameters of the set of DMRSs, and perform one or more operations in accordance with the control information.

Another UE for wireless communications is described. The UE may include means for receiving a set of DMRSs associated with a downlink control channel, where the set of DMRSs is received in accordance with one or more parameters, and where the one or more parameters are indicative of control information for the UE, means for identifying the control information that is indicated by the one or more parameters of the set of DMRSs, and means for performing one or more operations in accordance with the control information.

A non-transitory computer-readable medium storing code for wireless communications is described. The code may include instructions executable by one or more processors to receive a set of DMRSs associated with a downlink control channel, where the set of DMRSs is received in accordance with one or more parameters, and where the one or more parameters are indicative of control information for the UE, identify the control information that is indicated by the one or more parameters of the set of DMRSs, and perform one or more operations in accordance with the control information.

Some examples of the method, UEs, and non-transitory computer-readable medium described herein may further include operations, features, means, or instructions for receiving one or more control messages indicating a configuration of one or more search space sets or one or more control resource sets, or any combination thereof, that use the set of DMRSs having the one or more parameters indicative of the control information, where receiving the set of DMRSs may be in accordance with the configuration.

Some examples of the method, UEs, and non-transitory computer-readable medium described herein may further include operations, features, means, or instructions for receiving an indication of a mapping between the one or more parameters and the control information, where the control information may be identified in accordance with the mapping.

In some examples of the method, UEs, and non-transitory computer-readable medium described herein, the one or more parameters include a time-domain location of the set of DMRSs and the method, apparatuses, and non-transitory computer-readable medium may include further operations, features, means, or instructions for determining a threshold aggregation level associated with the downlink control channel using the time-domain location of the set of DMRSs, where performing the one or more operations includes performing blind decoding for the downlink control channel in accordance with the threshold aggregation level.

In some examples of the method, UEs, and non-transitory computer-readable medium described herein, the one or more parameters include a density of the set of DMRSs across one or more symbol periods and the method, apparatuses, and non-transitory computer-readable medium may include further operations, features, means, or instructions for determining a threshold aggregation level associated with the downlink control channel using the density of the set of DMRSs, where performing the one or more operations includes performing blind decoding for the downlink control channel in accordance with the threshold aggregation level.

Some examples of the method, UEs, and non-transitory computer-readable medium described herein may further include operations, features, means, or instructions for transmitting a capability message indicating that the UE supports the one or more operations, where receiving the set of DMRSs having the one or more parameters indicative of the control information may be in accordance with the capability message.

In some examples of the method, UEs, and non-transitory computer-readable medium described herein, the one or more parameters include a time-domain location of the set of DMRSs, a frequency-domain location of the set of DMRSs, a comb offset of the set of DMRSs, a frequency-domain density of the set of DMRSs, or any combination thereof.

In some examples of the method, UEs, and non-transitory computer-readable medium described herein, the control information includes a physical downlink control channel skipping indication, a search space set group switching indication, an indication of a threshold quantity of blind decoding attempts, a blind decoding priority, a monitoring periodicity associated with a search space set, a quantity of monitoring occasions associated with a search space set, a size of a control resource set, a threshold aggregation level associated with the downlink control channel, or any combination thereof.

In some examples of the method, UEs, and non-transitory computer-readable medium described herein, the one or more parameters include a power offset corresponding to the set of DMRSs and the power offset may be associated with an aggregation level of the downlink control channel.

In some examples of the method, UEs, and non-transitory computer-readable medium described herein, the one or more parameters include a location associated with the set of DMRSs or a pattern associated with the set of DMRSs, or both, the control information indicates a power offset corresponding to the set of DMRSs, and the power offset may be relative to one or more other reference signals.

In some examples of the method, UEs, and non-transitory computer-readable medium described herein, performing the one or more operations may include operations, features, means, or instructions for powering up one or more radio components of the UE in accordance with the control information, where the control information includes an indication to power up the one or more radio components.

In some examples of the method, UEs, and non-transitory computer-readable medium described herein, performing the one or more operations may include operations, features, means, or instructions for monitoring for the downlink control channel using a physical downlink control channel monitoring scheme, where the control information includes an indication of the physical downlink control channel monitoring scheme.

In some examples of the method, UEs, and non-transitory computer-readable medium described herein, a threshold quantity of non-overlapping control channel elements associated with the downlink control channel may be in accordance with the set of DMRSs having the one or more parameters indicative of the control information.

A method for wireless communications by a network entity is described. The method may include configuring, for a set of DMRSs, one or more parameters that are indicative of control information associated with one or more operations to be performed by a UE and outputting the set of DMRSs in association with a downlink control channel, where the set of DMRSs are output in accordance with the one or more parameters.

A network entity for wireless communications is described. The network entity may include one or more memories storing processor executable code, and one or more processors coupled with the one or more memories. The one or more processors may individually or collectively be operable to execute the code to cause the network entity to configuring, for a set of DMRSs, one or more parameters that be indicative of control information associated with one or more operations to be performed by a UE and output the set of DMRSs in association with a downlink control channel, where the set of DMRSs are output in accordance with the one or more parameters.

Another network entity for wireless communications is described. The network entity may include means for configuring, for a set of DMRSs, one or more parameters that are indicative of control information associated with one or more operations to be performed by a UE and means for outputting the set of DMRSs in association with a downlink control channel, where the set of DMRSs are output in accordance with the one or more parameters.

A non-transitory computer-readable medium storing code for wireless communications is described. The code may include instructions executable by one or more processors to configuring, for a set of DMRSs, one or more parameters that be indicative of control information associated with one or more operations to be performed by a UE and output the set of DMRSs in association with a downlink control channel, where the set of DMRSs are output in accordance with the one or more parameters.

Some examples of the method, network entities, and non-transitory computer-readable medium described herein may further include operations, features, means, or instructions for outputting one or more control messages indicating a configuration of one or more search space sets or one or more control resource sets, or any combination thereof, that use the set of DMRSs having the one or more parameters indicative of the control information, where outputting the set of DMRSs may be in accordance with the configuration.

Some examples of the method, network entities, and non-transitory computer-readable medium described herein may further include operations, features, means, or instructions for outputting an indication of a mapping between the one or more parameters and the control information, where the one or more parameters may be indicative of the control information in accordance with the mapping.

In some examples of the method, network entities, and non-transitory computer-readable medium described herein, the one or more parameters include a time-domain location of the set of DMRSs and a threshold aggregation level associated with the downlink control channel corresponds to the time-domain location of the set of DMRSs.

In some examples of the method, network entities, and non-transitory computer-readable medium described herein, the one or more parameters include a density of the set of DMRSs across one or more symbol periods and a threshold aggregation level associated with the downlink control channel corresponds to the density of the set of DMRSs.

Some examples of the method, network entities, and non-transitory computer-readable medium described herein may further include operations, features, means, or instructions for obtaining a capability message indicating that the UE supports the one or more operations, where outputting the set of DMRSs having the one or more parameters indicative of the control information may be in accordance with the capability message.

In some examples of the method, network entities, and non-transitory computer-readable medium described herein, the one or more parameters include a time-domain location of the set of DMRSs, a frequency-domain location of the set of DMRSs, a comb offset of the set of DMRSs, a frequency-domain density of the set of DMRSs, or any combination thereof.

In some examples of the method, network entities, and non-transitory computer-readable medium described herein, the control information includes a physical downlink control channel skipping indication, a search space set group switching indication, an indication of a threshold quantity of blind decoding attempts, a blind decoding priority, a monitoring periodicity associated with a search space set, a quantity of monitoring occasions associated with a search space set, a size of a control resource set, a threshold aggregation level associated with the downlink control channel, or any combination thereof.

In some examples of the method, network entities, and non-transitory computer-readable medium described herein, the one or more parameters include a power offset corresponding to the set of DMRSs and the power offset may be associated with an aggregation level of the downlink control channel.

In some examples of the method, network entities, and non-transitory computer-readable medium described herein, the one or more parameters include a location associated with the set of DMRSs or a pattern associated with the set of DMRSs, or both, the control information indicates a power offset corresponding to the set of DMRSs, and the power offset may be relative to one or more other reference signals.

Some examples of the method, network entities, and non-transitory computer-readable medium described herein may further include operations, features, means, or instructions for identifying data that may be available for communications with the UE, where the control information includes an indication for the UE to power up one or more radio components to receive the identified data.

In some examples of the method, network entities, and non-transitory computer-readable medium described herein, the control information includes an indication of a physical downlink control channel monitoring scheme.

In some examples of the method, network entities, and non-transitory computer-readable medium described herein, a threshold quantity of non-overlapping control channel elements associated with the downlink control channel may be in accordance with the set of DMRSs having the one or more parameters indicative of the control information.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports demodulation reference signal (DMRS)-based control information signaling in accordance with one or more aspects of the present disclosure.

FIG. 2 shows an example of a wireless communications system that supports DMRS-based control information signaling in accordance with one or more aspects of the present disclosure.

FIG. 3 shows an example of a process flow that supports DMRS-based control information signaling in accordance with one or more aspects of the present disclosure.

FIGS. 4 and 5 show block diagrams of devices that support DMRS-based control information signaling in accordance with one or more aspects of the present disclosure.

FIG. 6 shows a block diagram of a communications manager that supports DMRS-based control information signaling in accordance with one or more aspects of the present disclosure.

FIG. 7 shows a diagram of a system including a device that supports DMRS-based control information signaling in accordance with one or more aspects of the present disclosure.

FIGS. 8 and 9 show block diagrams of devices that support DMRS-based control information signaling in accordance with one or more aspects of the present disclosure.

FIG. 10 shows a block diagram of a communications manager that supports DMRS-based control information signaling in accordance with one or more aspects of the present disclosure.

FIG. 11 shows a diagram of a system including a device that supports DMRS-based control information signaling in accordance with one or more aspects of the present disclosure.

FIGS. 12 through 15 show flowcharts illustrating methods that support DMRS-based control information signaling in accordance with one or more aspects of the present disclosure.

### DETAILED DESCRIPTION

In some wireless communications systems, a user equipment (UE) may receive control information from a network entity via a physical downlink control channel (PDCCH). PDCCH is used to carry downlink control information (DCI) messages associated with one or multiple users, and each UE may decode the DCI messages that are intended for that UE. To reduce power consumption and overhead at the UE, a relatively limited set of control channel element (CCE) locations may be specified for transmitted DCI. These CCEs may be grouped (e.g., in groups of one, two, four, and eight CCEs), and a set of CCE locations in which the user equipment may find relevant DCI may be specified. These CCEs may be known as a search space. A UE may attempt to decode DCI by performing a process known as a blind decode, during which search spaces may be randomly decoded until the DCI is detected. During a blind decode, the UE may attempt to descramble all potential DCI messages using an identifier (e.g., a cell-radio network temporary identifier (C-RNTI)), and perform a cyclic redundancy check (CRC) to determine whether the attempt was successful.

In some cases, a demodulation reference signal (DMRS) may be used to enhance the demodulation process for messages carried via the PDCCH. As such, DMRS transmission may be used to improve demodulation efficiency, thereby promoting data link stability and overall system performance. For instance, a DMRS may provide a coherent reference for a receiving device (e.g., a UE) and may enable accurate decoding of a received signal. Here, the DMRS may assist the receiving device in estimating a channel's characteristics (e.g., path conditions), which may be used to demodulate a corresponding signal (e.g., a signal transmitted via PDCCH).

Blind decoding may result in a significant amount of power consumed by the UE. For example, a UE may perform up to 44 decoding attempts per slot to determine if DCI is present or not. As such, various techniques may be implemented to reduce the amount of blind decoding that a UE performs when monitoring for PDCCH. It may also be desirable to enable UEs to detect control information relevant to the UE prior to decoding the DCI, which may also assist in enabling the techniques that limit blind decoding and other operations.

Techniques described herein enable a UE to identify control information using the DMRSs associated with a PDCCH. More specifically, one or more parameters associated with the DMRS may indicate the control information (which may be referred to as control channel side information or some other terminology), and the UE may identify the control information via the DMRS parameters (e.g., before DCI is detected/decoded by the UE). In some aspects, the one or more parameters may include a location of the DMRS in a time domain, a location of the DMRS in a frequency domain, a time- and frequency-domain location of the DMRS, a DMRS comb offset, a DMRS density in the frequency domain, among other examples.

The UE may utilize the control information indicated by the DMRS parameters to perform one or more operations. For instance, the control information indicated by the one or more parameters may signal whether the UE is to adapt its PDCCH monitoring behavior. In such examples, the UE may modify how PDCCH is monitored based on the control information indicating that the UE, for example, perform PDCCH skipping, search space set group (SSSG) switching, or other techniques used to reduce blind decoding. In other examples, the control information indicated by the one or more parameters may provide a wake-up indication to the UE, and the UE (e.g., operating in a low-power receiver mode or other power-saving mode) may activate or otherwise power up one or more radio components based on the detection of the one or more DMRS parameters. In any case, the DMRS parameters may provide additional information to the UE, which may enable the UE to determine some control information and/or perform one or more operations prior to the detection and decoding of DCI, and may support techniques that reduce or minimize blind decoding. Moreover, the described techniques may enable more efficient resource utilization by offloading some information from DCI resources via the use of the DMRS parameters.

Aspects of the disclosure are initially described in the context of wireless communications systems. Aspects of the disclosure are described with reference to a process flow. Aspects of the disclosure are further illustrated by and described with reference to apparatus diagrams, system diagrams, and flowcharts that relate to DMRS-based control information signaling.

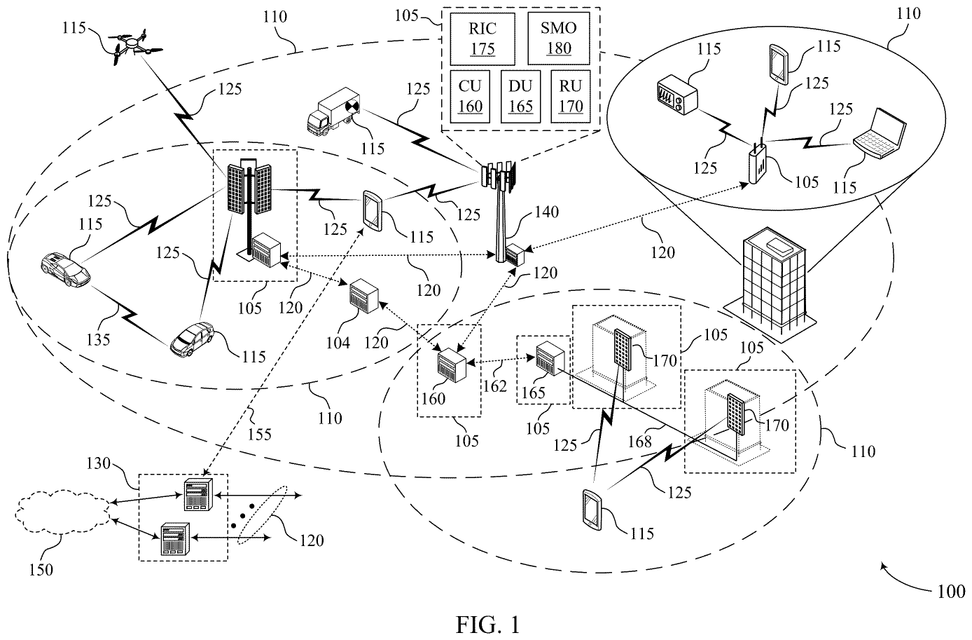

FIG. 1 shows an example of a wireless communications system 100 that supports DMRS-based control information signaling in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support DMRS-based control information signaling as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

PDCCH carries DCI in CCEs, which may, for example, include logically-contiguous resource element groups (REGs), where each REG contains a quantity of resource elements (REs). DCI includes information regarding downlink scheduling assignments, uplink resource grants, transmission scheme, uplink power control, hybrid automatic repeat request (HARQ) information, a modulation and coding scheme (MCS), and other information. The size and format of the DCI messages may differ depending on the type and amount of information that is carried by the DCI. For example, if spatial multiplexing is supported, the size of the DCI message may be relatively large compared to contiguous frequency allocations. Similarly, for a system that employs MIMO, the DCI may include additional signaling information. The DCI size and format may depend on an amount of information as well as other factors such as bandwidth, a number of antenna ports, duplexing mode, or the like.

In some cases, a DMRS (sometimes designated DM-RS) may be used to enhance the demodulation process for messages carried via the PDCCH. As such, DMRS transmission may be used to improve demodulation efficiency, thereby promoting data link stability and overall system performance. For instance, a DMRS may provide a coherent reference for a receiving device (e.g., a UE) and may enable accurate decoding of a received signal. Here, the DMRS may assist the receiving device in estimating a channel's characteristics (e.g., path conditions), which may be used to demodulate a corresponding signal (e.g., a signal transmitted via PDCCH).

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET), which may include a set of physical resources allocated by the network to one or more UEs 115, and which may be used for control purposes (e.g., synchronization, scheduling, and signaling)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. HARQ feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A quasi co-location (QCL) relationship between one or more transmissions or signals may refer to a relationship between the antenna ports (and the corresponding signaling beams) of the respective transmissions. For example, one or more antenna ports may be implemented by a network entity 105 for transmitting at least one or more reference signals (such as a downlink reference signal, a synchronization signal block (SSB), or the like) and control information transmissions to a UE 115. However, the channel properties of signals sent via the different antenna ports may be interpreted (e.g., by a receiving device) to be the same (e.g., despite the signals being transmitted from different antenna ports), and the antenna ports (and the respective beams) may be described as being quasi co-located (QCLed). QCLed signals may enable the UE 115 to derive the properties of a first signal (e.g., delay spread, Doppler spread, frequency shift, average power) transmitted via a first antenna port from measurements made on a second signal transmitted via a second antenna port. Put another way, if two antenna ports are categorized as being QCLed in terms of, for example, delay spread then the UE 115 may determine the delay spread for one antenna port (e.g., based on a received reference signal, such as CSI-RS) and then apply the result to both antenna ports. Such techniques may avoid the UE 115 determining the delay spread separately for each antenna port. In some cases, two antenna ports may be said to be spatially QCLed, and the properties of a signal sent over a directional beam may be derived from the properties of a different signal over another, different directional beam. That is, QCL relationships may relate to beam information for respective directional beams used for communications of various signals.

Different types of QCL relationships may describe the relationship between two different signals or antenna ports. For instance, QCL-TypeA may refer to a QCL relationship between signals including Doppler shift, Doppler spread, average delay, and delay spread. QCL-TypeB may refer to a QCL relationship including Doppler shift and Doppler spread, whereas QCL-TypeC may refer to a QCL relationship including Doppler shift and average delay. A QCL-TypeD may refer to a QCL relationship of spatial parameters, which may indicate a relationship between two or more directional beams used to communicate signals. Here, the spatial parameters may indicate that a first beam used to transmit a first signal may be similar (or the same) as another beam used to transmit a second, different, signal, or, that the same receive beam may be used to receive both the first and the second signal. Thus, the beam information for various beams may be derived through receiving signals from a transmitting device, where, in some cases, the QCL information or spatial information may help a receiving device efficient identify communications beams (e.g., without having to sweep through a large quantity of beams to identify a beam (e.g., the beam having a highest signal quality)). In addition, QCL relationships may exist for both uplink and downlink transmissions and, in some cases, a QCL relationship may also be referred to as spatial relationship information.

In some examples, transmission configuration indicator (TCI) states may include one or more parameters associated with a QCL relationship between transmitted signals. For example, each TCI state includes parameters for configuring a QCL relationship between one or two downlink reference signals and the DMRS ports of PDSCH, the DMRS port of PDCCH or the CSI-RS port(s) of a CSI-RS resource. The QCL relationship is configured by a first higher layer parameter for the first downlink reference signal, and by a second higher layer parameter for the second downlink reference signal (if configured). That is, a network entity 105 may configure a QCL relationship that provides a mapping between a reference signal and antenna ports of another signal, and the TCI state may be indicated to the UE 115 by the network entity 105. In some cases, a set of TCI states (e.g., a list of TCI states) may be indicated to a UE 115 via RRC signaling, where some quantity of TCI states may be configured via RRC and one or more TCI states may be indicated (e.g., activated) via a medium access control (MAC)-control element (MAC-CE), and further indicated via DCI (e.g., within a CORESET). The QCL relationship associated with the TCI state (and further established through higher-layer parameters) may provide the UE 115 with the QCL relationship for respective antenna ports and reference signals transmitted by the network entity 105.

The wireless communications system 100 may support the use of one or more parameters associated with a DMRS to identify control information intended for a UE 115. As an example, a DMRS associated with a PDCCH may be transmitted to the UE 115, and one or more parameters (such as a frequency-domain location of the DMRS, a time-domain location of the DMRS, a comb offset of the DMRS, a density of the DMRS, or the like) may indicate control information to the UE 115. In some examples, the control information may be used by the UE 115 to perform one or more operations, such as for PDCCH monitoring, low-power operations, or the like. As an example, the control information indicated via the DMRS parameters may indicate that the UE 115 is to use PDCCH skipping or other operations that may modify how the UE 115 monitors for PDCCH. In other examples, the control information indicated via the DMRS parameters may provide an indication to the UE 115 that data is available for the UE 115, and the UE 115 may, in response, transition out of a power-saving mode to activate one or more radio components to receive the available data. In any case, the control information indicated via the DMRS parameters may be separate from and/or in addition to control information carried via DCI.

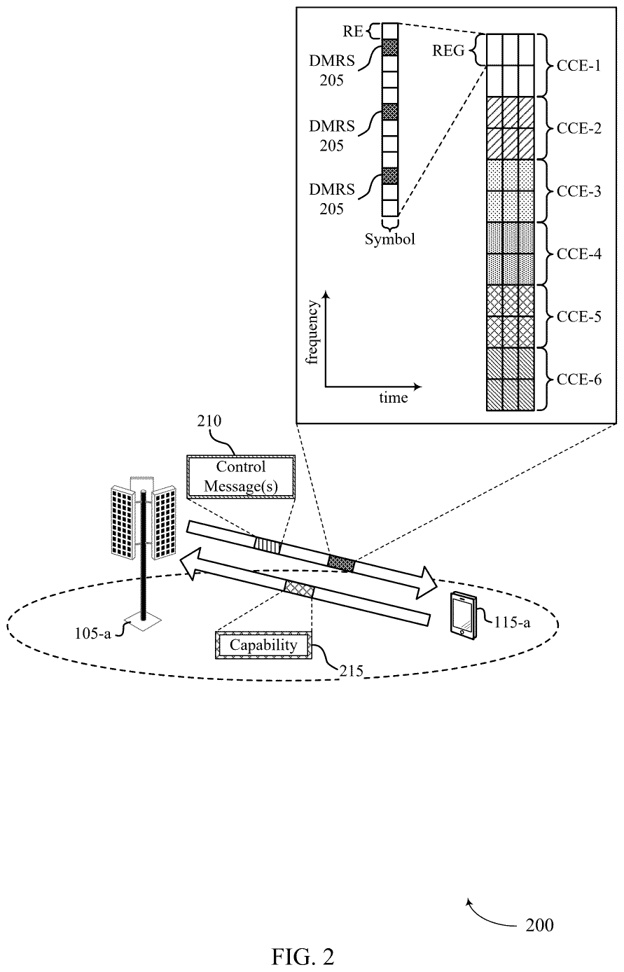

FIG. 2 shows an example of a wireless communications system 200 that supports DMRS-based control information signaling in accordance with one or more aspects of the present disclosure. The wireless communications system 200 may implement aspects of or may be implemented by aspects of the wireless communications system 100. For example, the wireless communications system 200 includes a UE 115-a and a network entity 105-a, which may be examples of a UE 115 and a network entity 105 described with respect to FIG. 1. In some examples, the wireless communications system 200 may support techniques for utilizing control information that is indicated by DMRS parameters.

In the wireless communications system 200, the UE 115-a may receive control information from the network entity 105-a via a PDCCH. PDCCH is used to carry DCI messages associated with one or multiple users, and each UE 115 may decode the DCI messages that are intended for that UE 115. In some cases, a set of one or more DMRS (e.g., including one or more instances of DMRS 205) may be used to enhance the demodulation process for messages carried via the PDCCH. DMRS transmission may be used to improve demodulation efficiency, thereby promoting data link stability and overall system performance. For instance, a DMRS 205 may provide a coherent reference for a receiving device (e.g., a UE) and may enable accurate decoding of a received signal. Here, the DMRS 205 may assist the receiving device in estimating a channel's characteristics (e.g., path conditions), which may be used to demodulate a corresponding signal (e.g., a signal transmitted via PDCCH).

In some examples, the set of DMRSs may be mapped to each resource element group (REG) and on each OFDM symbol of a given PDCCH candidate. Each REG may include multiple resource elements (REs). A DMRS density (e.g., a ratio of DMRS REs to other control REs) may be the same for all of the REGs and, in some examples, DMRS positions may be distributed (e.g., evenly distributed) within an REG. A set of REGs may be included in a CCE (e.g., CCE-1 through CCE-6). As an example, a DMRS density per REG may be 1/4 (e.g., one DMRS 205 for every four consecutive REs) for a normal cyclic prefix (CP) and an extended CP. In some examples, the set of DMRSs may include the DMRS 205 mapped to respective REs (e.g., REs having an index of 1, 5, and 9, respectively).

To reduce power consumption and overhead at the UE 115, a relatively limited set of CCE locations may be specified for DCI associated with a specific UE 115 (such as the UE 115-a). These CCEs may be grouped (e.g., in groups of one, two, four, and eight CCEs), and a set of CCE locations in which the user equipment may find relevant DCI may be specified. These CCEs may be known as a search space. A UE may attempt to decode DCI by performing a process known as a blind decode, during which search spaces may be randomly decoded until the DCI is detected. During a blind decode, the UE may attempt to descramble all potential DCI messages using an identifier (e.g., a cell-radio network temporary identifier (C-RNTI)), and perform a cyclic redundancy check (CRC) to determine whether the attempt was successful.

In some examples, there may be a configurable identifier (ID) for the DMRS 205 (e.g., a PDCCH DMRS), which may be used for an initialization of a DMRS sequence and/or scrambling. As an example, for each CORESET configured by a physical broadcast channel (PBCH), a physical cell ID may be used for DMRS sequence initialization. Here, a value range of the configurable ID may be the same as a value range for the physical cell ID (e.g., 10 bits). Additionally, or alternatively, each CORESET configured by remaining minimum system information (RMSI) may be configured with a configurable ID for DMRS sequence initialization via the RMSI. In other cases, if the CORESET is not configured via the RMSI, the physical cell ID may be used for DMRS sequence initialization. In some examples, for each CORESET configured via UE-specific RRC signaling, the UE 115-a may be configured with a configurable ID,

$${N}_{ID}^{{n}_{SCID}} ,$$

for the DMRS Sequence initialization, where

$${N}_{ID}^{{n}_{SCID}}$$

may be a 16-bit scrambling ID, for example, with a default value of the physical cell ID and 6 known bits (e.g., ‘000000’).

A DMRS 205 and a PDCCH payload (e.g., after coding) may be scrambled by a sequence (e.g., a length-31 Gold sequence). The DMRS sequence for PDCCH may be obtained in accordance with a reference point in the frequency domain. As an example, the reference point may be a first physical resource block (PRB) (e.g., PRB 0 of common PRB indexing for a UE-specific CORESET) or a second PRB (e.g., PRB 0 of an initial active downlink bandwidth part (BWP) for a CORESET configured via PBCH and/or RMSI). In some cases, a QCL configuration and/or indication may be on a per-CORESET basis.

Blind decoding performed by the UE 115-a may result in a significant amount of power consumed by the UE 115-a. For example, the UE 115-a may perform up to 44 decoding attempts per slot to determine if DCI is present or not. The corresponding power consumption of the UE 115-a during blind decoding may accordingly be prohibitive to power saving and/or battery life. As such, various techniques may be implemented to reduce the amount of blind decoding that the UE 115-a performs when monitoring for PDCCH. Such techniques may generally be referred to as PDCCH monitoring adaptation or some other terminology. As an example, for RRC-connected UEs 115 (such as UE 115-a), PDCCH skipping and/or SSSG switching techniques may be applied for some search spaces (e.g., for a Type3 common search space (CSS) and/or UE-specific search space (USS)) for implementing power saving schemes for the UE 115. In some examples, other CSSs may be monitored regardless of SSSG switching and PDCCH skipping techniques. In some examples, PDDCH monitoring adaptation may be applied to a scheduling cell (e.g., for self- and cross-carrier scheduling), and one or more DCI may be used to indicate the type and/or activation of the PDCCH monitoring adaptation.

As an example, one or more DCI formats (e.g., DCI format 1_1, DCI format 1_1, DCI format 0_1, DCI format 0_2, or any combination thereof) may be used to indicate a set of one or more behaviors associated with PDCCH monitoring adaptation. In such cases, the respective behaviors may be mapped to a codepoint of an indication field in the DCI (e.g., a scheduling DCI). The set of one or more behaviors may include a first behavior and a second behavior associated with PDCCH skipping, where PDCCH skipping is not activated and/or triggered under the first behavior, but PDCCH monitoring may be stopped and/or paused for some duration (e.g., some higher-layer-configured value) in accordance with the second behavior. The set of one or more behaviors may further include behaviors associated with SSSG switching, including a third behavior, a fourth behavior, and a fifth behavior. The third behavior may be associated with stopping (e.g., refraining from) monitoring of search space sets associated with some SSSGs (such as SSSG #1 and SSSG #2) and monitoring search space sets associated with another SSSG (such as SSSG #0). The fourth behavior may be associated with stopping monitoring of search space sets associated with one or more SSSGs (such as SSSG #0 and SSSG #2) and monitoring search space sets associated with a different SSSG (such as SSSG #1). Similarly, the fifth behavior may be associated with stopping monitoring of search space sets associated with multiple SSSGs (such as SSSG #0 and SSSG #1) and monitoring search space sets associated with an SSSG (such as SSSG #2). For some SSSG switching techniques, at a first slot after switching from one SSSG to another SSSG (e.g., switching to SSSG #1 or SSSG #2), the UE 115-a may set an SSSG switching timer. The timer may be reset after a slot that the UE 115-a detects a DCI format with CRC scrambled by an RNTI (e.g., a C-RNTI, a configured scheduling-RNTI (CS-RNTI), and/or a modulation and coding scheme-cell-RNTI (MCS-C-RNTI) (e.g., for a unicast PDCCH)). Otherwise, the timer may be decreased by one after each slot. In some examples, if the UE 115-a monitors PDCCH according to SSSG #1 or SSSG #2 and the timer expires (e.g., the timer value reaches zero), the UE 115-a may begin monitoring PDCCH using SSSG #0 (e.g., a default SSSG), for example, after an application delay.

It may also be desirable to enable the UE 115-a to detect control information relevant to the UE 115-a prior to decoding the DCI, which may provide improved implementation of techniques for limiting blind decoding. As an example, additional use cases associated with DMRS detection (e.g., by a DMRS detection block in a modem of the UE 115-a) may be used to further enhance device efficiency and power saving. Such use cases may include signaling control information (e.g., control channel side information) to improve the power and efficiency of PDCCH decoding procedures (e.g., before DCI decoding). For instance, at least a portion of control information otherwise carried via DCI may be identified using DMRS detection by a receiving device (e.g., the UE 115-a). Further, even without decoding the DCI, PDCCH adaptation techniques may be achieved through DMRS detection, which may serve to provide power saving for the UE 115-a. In some other examples, DMRS may be used to carry relatively light (e.g., minimized, low-overhead) control information for low-power operation modes used by the UE 115-a, among other use cases. Accordingly, the utilization of DMRS to carry control information may promote resource utilization or, in some other cases, may provide some level of redundancy for control information intended for the UE 115-a.

Thus, the techniques described herein may enable the UE 115-a to identify control information using the DMRSs 205 associated with a PDCCH. In particular, one or more parameters associated with the DMRS 205 may indicate the control information (which may be referred to as control channel side information or some other terminology), and the UE 115-a may identify the control information via the DMRS parameters (e.g., before DCI is detected/decoded by the UE 115-a).

In some aspects, the one or more parameters may include a location of the DMRS 205 in a time domain (e.g., a DMRS position in time), a location of the DMRS 205 in a frequency domain (e.g., a DMRS position in frequency), a time- and frequency-domain location of the DMRS 205, a DMRS comb offset, a DMRS density in the frequency domain, among other examples. In any case, different DMRS parameters may be used to indicate different control information. For example, a first DMRS location in time and/or frequency may indicate a first set of control information, whereas a second DMRS location in time and/or frequency may indicate a second set of control information. In some cases, the location of the DMRS 205 in the frequency domain may correspond to a PDCCH candidate location. In some aspects, the DMRS comb offset for the DMRS 205 may be dynamic (e.g., not fixed) and different comb offsets may be used to indicate different control information to the UE 115-a. Likewise, the DMRS density may be dynamically configured (e.g., may not be fixed) and respective DMRS densities in the frequency domain may correspond to different control information. In some examples, one or more combinations of DMRS parameters may be used to signal the control information.

The UE 115-a may use the control information indicated by the DMRS parameters to perform one or more operations. For instance, the control information indicated by the one or more parameters may signal whether the UE 115-a is to adapt its PDCCH monitoring behavior. In such examples, the UE 115-a may modify how PDCCH is monitored based on the control information indicating that the UE 115-a, for example, perform PDCCH skipping, SSSG switching, or other techniques used to reduce blind decoding operations. In other examples, the control information indicated by the one or more DMRS parameters may provide a wake-up indication to the UE 115-a, and the UE 115-a (e.g., operating in a low-power receiver mode or other power-saving mode) may activate or otherwise power up one or more radio components based on the detection of the one or more DMRS parameters. In any case, the DMRS parameters may provide additional information to the UE 115-a, which may enable the UE 115-a to determine some control information and/or perform one or more operations prior to the detection and decoding of DCI, and may support techniques that reduce or minimize blind decoding. Moreover, the described techniques may enable more efficient resource utilization by offloading some information from DCI resources to the one or more DMRS parameters.

In some examples, the network entity 105-a may transmit one or more control messages 210 to the UE 115-a, which may indicate a configuration associated with the DMRS parameters used for control information signaling. As an example, the network entity 105-a may configure one or more search spaces and/or CORESETs that use the DMRS 205 (e.g., use the parameters of the DMRS 205) for carrying the control channel information, which may reduce the impact on network scheduling flexibility as well as UE reception complexity. That is, there may be some specific (e.g., “special”) search spaces and/or CORESETs that are used for the indication of control information via the DMRS 205 (e.g., using the one or more DMRS parameters). In some examples, there may be a mapping between the DMRS parameters and the control information indicated by the DMRS parameters. Such mapping may be configured or pre-configured, and may be indicated to the UE 115-a via the one or more control messages 210. In some aspects, the UE 115-a may transmit a capability message 215 that indicates the UE's support for detecting the one or more DMRS parameters for identifying the control information carried by the DMRS parameters. For example, the capability message 215 may indicate a capability of the UE 115-a associated with DMRS adaptation in the time domain, in the frequency domain, in the power domain, or any combination thereof.

The mapping between the DMRS parameters and the control information may be an example of a bitmap, where some bit(s) or bit combinations indicated by the DMRS parameters may correspond to one or more aspects of control signaling. As an example, the bitmap may provide, to the UE 115-a, a PDCCH skipping indication, an SSSG switching indication, a threshold (e.g., maximum) quantity of blind decoding attempts to be performed by the UE 115-a, a priority of blind decoding, search space related information, CORESET size adaptation information, aggregation level information, or any combination thereof.

In some examples, the threshold quantity of blind decoding attempts may be dynamic and/or configurable for the UE 115-a, and the bitmap may accordingly indicate which threshold quantity of blind decoding attempts the UE 115-a may use for blind decoding. In some aspects, the network entity 105-a may define multiple rules of blind decoding priority, where the DMRS 205 (e.g., the one or more parameters of the DMRS 205) may dynamically indicate to the UE 115-a which rule should be applied for blind decoding. The search space related information provided by the one or more DMRS parameters (e.g., in accordance with the mapping) may include a PDCCH monitoring periodicity, an indication of one or more PDCCH monitoring occasions, or the like. In examples where the control information provided by the DMRS parameter indicates the CORESET size adaptation information, the control information may indicate a CORESET size, which may be provided with the information carried by a DMRS 205 included in a first symbol period in the CORESET. Such techniques may enable a dynamic trade-off between efficiency of rate matching and PDCCH capacity, among other advantages.

The aggregation level information provided by the control information signaled via the DMRS parameters may include a threshold aggregation level associated with PDCCH reception (e.g., a minimum aggregation level supported by the CORESET, a maximum aggregation level supported by the CORESET). For instance, a quantity of symbols used for DMRS 205 in a CORESET may be dynamic, and may be based on a supported threshold aggregation level associated with the CORESET. As an example, for a relatively small aggregation level, the DMRS 205 may be transmitted on a single symbol of the CORESET, whereas for a relatively large aggregation level, the DMRS 205 may be transmitted on all symbols of the CORESET. Based on the DMRS location in the time domain, the UE 115-a may derive the threshold aggregation level (e.g., the minimum and/or maximum aggregation level) associated with the CORESET, and the UE 115-a may reduce or minimize its blind decoding operations based on the derived aggregation level. That is, the control information may be used to dynamically indicate an aggregation level associated with the PDCCH, and the UE 115-a may accordingly adapt its blind decoding based on the indicated aggregation level.

In some aspects, the density of the DMRS 205 in the frequency domain may be variable across CORESET symbols based on the aggregation level associated with the CORESET. In such examples, an aggregation level-dependent adaptation of DMRS density in the time domain and frequency domain may provide additional information to the UE 115-a, for example, for reducing the hypothesis testing of PDCCH blind decoding. Further, based on detecting the DMRS density in different symbols, the UE 115-a may derive the threshold aggregation level (e.g., minimum aggregation level, maximum aggregation level) associated with the CORESET, which may be used by the UE 115-a to reduce blind decoding operation, thereby reducing power consumption and enhancing power savings. Further, as described herein, joint time and frequency location information of the DMRS 205 may be used for control information signaling.

The DMRS parameters used to indicate the control information may additionally, or alternatively, include a DMRS power offset. In some examples, transmission power adaptation for the DMRS 205 may be useful when time and/or frequency resource allocation for PDCCH may be relatively limited (e.g., associated with a narrow-band transmitter/receiver, low-latency PDCCH decoding, or the like). For instance, with a relatively high aggregation level, power boosting a DMRS transmission (e.g., 3 dB power boosting) may be as effective as doubling the aggregation level, whereas for a relatively low to medium aggregation level, power boosting for the DMRS transmission (e.g., 3 dB power boosting) may be relatively less effective than doubling the aggregation level. In some aspects of the present disclosure, a DMRS power offset may be used to carry the control information, where the power offset may be dependent on (e.g., based on) the aggregation level. In some examples, the DMRS location and/or pattern may be used to indicate a DMRS power offset, which may be relative to one or more reference signals (e.g., one or more SSBs, one or more tracking reference signals (TRSs), or the like).

In some examples, the control information may be used for one or more low-power modes utilized by the UE 115-a. As an example, the UE 115-a may operate in a low-power mode that includes one or more periods in which the UE 115-a may power down radio components to reduce power consumption. In such cases, the UE 115-a may implement one or more low-power receivers (e.g., radio components that consume minimal power but still enable the reception of signaling from other devices, such as the network entity 105-a). In accordance with the techniques described herein, the UE 115-a may receive the set of DMRSs and, based on the one or more parameters associated with the DMRS 205 included in the set of DMRSs, may wake up one or more radio components to communicate (e.g., transmit, receive) with the network entity 105-a. More specifically, the control information carried via the DMRS parameters may serve as a signal that indicates, to the UE 115-a, that data is available for communication. The UE 115-a may “wake up” in response to the detection of the DMRS 205 (and the corresponding parameters of the DMRS 205). Thus, the one or more DMRS parameters (which may be referred to as a dynamic DMRS 205) may be used for low-power receiver operations, where the detection of the DMRS 205 may not only be for reducing PDCCH monitoring and detection and PDCCH adaptation, but may further be used to provide control information providing other indications to the UE 115-a.

For signaling the control information using the one or more DMRS parameters, there may be different thresholds of non-overlapping CCEs defined. As an example, some systems may define a threshold (e.g., maximum) quantity of non-overlapping CCEs in each slot to limit the complexity of channel estimation. However, when using the DMRS parameters for indicating the control information, a different threshold (e.g., maximum) quantity of non-overlapping CCEs may be defined. Such techniques may be used to achieve a balance between system complexity, detection reliability, and control signaling capacity.

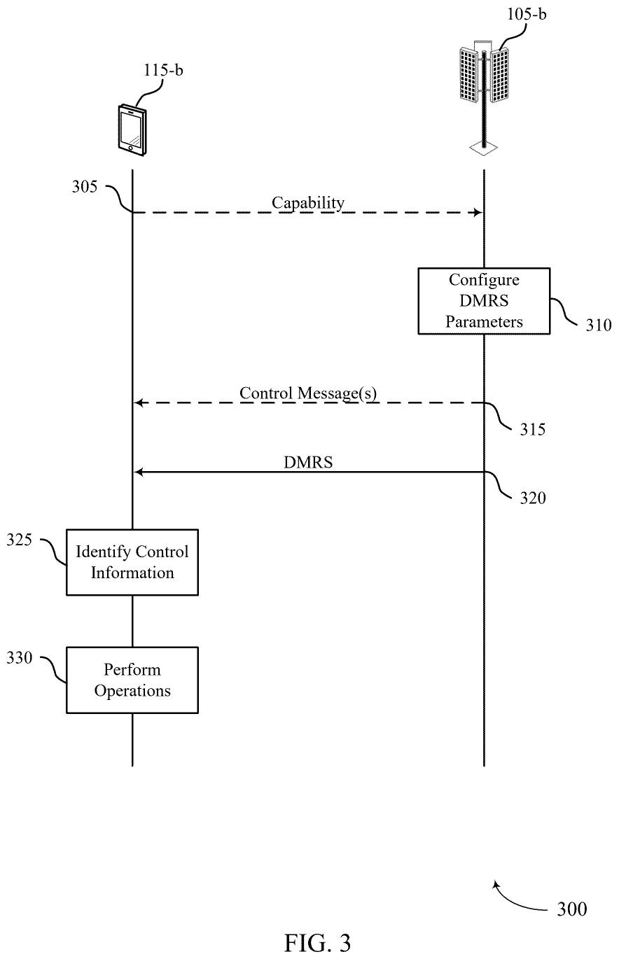

FIG. 3 shows an example of a process flow 300 that supports DMRS-based control information signaling in accordance with one or more aspects of the present disclosure. The process flow 300 may implement or be implemented to realize aspects of the wireless communications system 100 or the wireless communications system 200, as described with reference to FIGS. 1 and 2, respectively. The process flow 300 may include a UE 115-b and a network entity 105-b, which may be example of the corresponding devices described with reference to FIGS. 1 and 2.

Alternative examples of the following may be implemented. Some steps are performed in a different order than described or are not performed at all. In some implementations, steps may include additional features not mentioned below, or further steps may be added. Further, although the UE 115-b and network entity 105-b are shown performing the operations of the process flow 300, some aspects of some operations may also be performed by one or more other wireless communication devices.

At 305, the UE 115-b may transmit, and the network entity 105-b may obtain, a capability message indicating that the UE 115-b supports one or more operations, such as PDCCH adaptation and/or low-power reception operations. Additionally, or alternatively, the capability message may indicate whether the UE 115-b supports one or capabilities associated with utilizing control information indicated via one or more DMRS parameters.

At 310, the network entity 105-b may configure, for a set of DMRSs, one or more parameters that are indicative of control information associated with the one or more operations to be performed by the UE 115-b. In such cases, the network entity 105-b may identify one or more search space sets or one or more CORESETs, or any combination thereof, that support the use of the DMRS parameters indicative of the control information. In some examples, the configuration by the network entity 105-b may be based on the capability message received from the UE 115-b.

At 315, the network entity 105-b may output, and the UE 115-b may receive, one or more control messages indicating the configuration of the one or more search space sets or the one or more CORESETs, or any combination thereof, that use the set of DMRSs having the one or more parameters indicative of the control information. In some examples, the one or more control messages may be an example of RRC messages, MAC-CE, DCI, or other signaling. Additionally, or alternatively, the one or more control messages output at 315 may include an indication of a mapping (e.g., a bitmap) between the one or more parameters and the control information. In such cases, the one or more parameters are indicative of the control information in accordance with the mapping indicated by the network entity 105-b.

At 320, the network entity 105-b may output, and the UE 115-b may receive, the set of DMRSs that are associated with a downlink control channel (e.g., a PDCCH), where the set of DMRSs are output having with the one or more parameters indicative of the control information. For example, the set of DMRSs may be output having some location in a frequency domain, some location in a time domain, some time- and frequency-domain location, some comb offset, some density, or any combination thereof, that indicates the control information.

At 325, the UE 115-b may identify the control information that is indicated by the one or more parameters of the set of demodulation reference signals. As an example, the UE 115-b may perform DMRS detection to identify the one or more DMRS parameters that indicate the control information.

At 330, based on the control information indicated by the DMRS parameters, the UE 115-b may perform one or more operations. As an example, the UE 115-b may utilize PDCCH adaptation to monitor for PDCCH from the network entity 105-b, where the PDCCH adaptation may include PDCCH skipping, SSSG switching, or other techniques that enable power saving at the UE 115-b (e.g., by reducing or minimizing blind decoding). In some other examples, the UE 115-b may identify an aggregation level associated with the PDCCH using the control information indicated by the one or more parameters, and the UE 115-b may accordingly adjust its PDCCH monitoring based on the indicated aggregation level. In some other examples, the UE 115-b may be in a low-power mode, and the reception of the set of DMRSs (and detecting the one or more parameters indicative of the control information) may indicate that the UE 115-b is to wake up (e.g., power up one or more radio components) to receive additional data form the network entity 105-b.

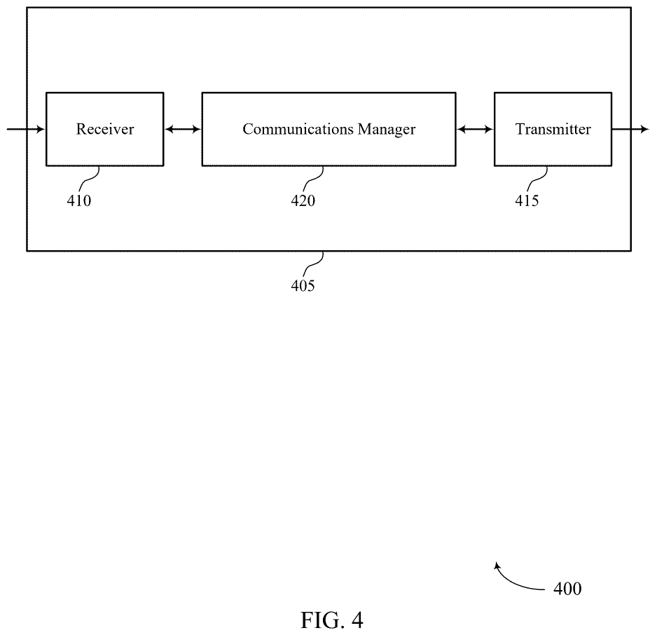

FIG. 4 shows a block diagram 400 of a device 405 that supports DMRS-based control information signaling in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to DMRS-based control information signaling). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to DMRS-based control information signaling). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of DMRS-based control information signaling as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving a set of DMRSs associated with a downlink control channel, where the set of DMRSs is received in accordance with one or more parameters, and where the one or more parameters are indicative of control information for the UE. The communications manager 420 is capable of, configured to, or operable to support a means for identifying the control information that is indicated by the one or more parameters of the set of DMRSs. The communications manager 420 is capable of, configured to, or operable to support a means for performing one or more operations in accordance with the control information.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced processing, reduced power consumption, more efficient utilization of communication resources, among other examples. For instance, by indicating some control information using DMRS parameters (e.g., offloading some control information to DMRS parameters), a UE may identify the control information prior to decoding DCI. As such, the UE may be provided with an “early” indication of such control information, enabling the UE to perform and/or modify one or more operations using the parameter-based control information. Such techniques may result in improved power usage by the UE.

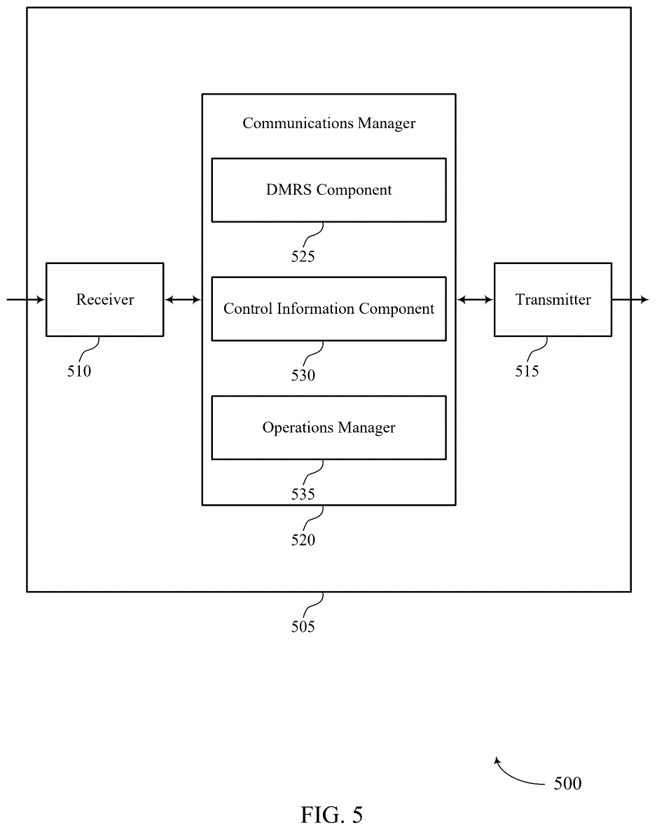

FIG. 5 shows a block diagram 500 of a device 505 that supports DMRS-based control information signaling in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to DMRS-based control information signaling). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to DMRS-based control information signaling). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of DMRS-based control information signaling as described herein. For example, the communications manager 520 may include a DMRS component 525, a control information component 530, an operations manager 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The DMRS component 525 is capable of, configured to, or operable to support a means for receiving a set of DMRSs associated with a downlink control channel, where the set of DMRSs is received in accordance with one or more parameters, and where the one or more parameters are indicative of control information for the UE. The control information component 530 is capable of, configured to, or operable to support a means for identifying the control information that is indicated by the one or more parameters of the set of DMRSs. The operations manager 535 is capable of, configured to, or operable to support a means for performing one or more operations in accordance with the control information.

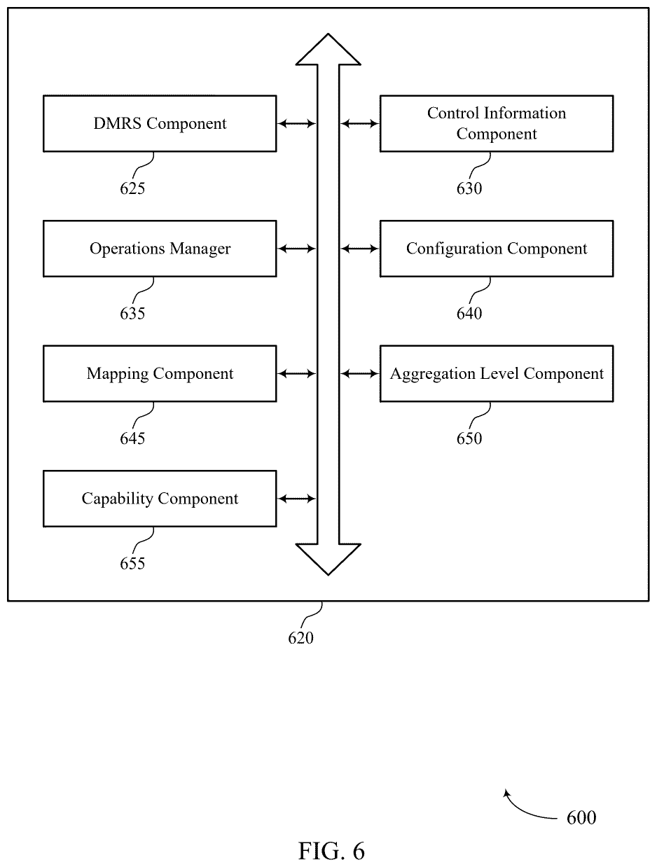

FIG. 6 shows a block diagram 600 of a communications manager 620 that supports DMRS-based control information signaling in accordance with one or more aspects of the present disclosure. The communications manager 620 may be an example of aspects of a communications manager 420, a communications manager 520, or both, as described herein. The communications manager 620, or various components thereof, may be an example of means for performing various aspects of DMRS-based control information signaling as described herein. For example, the communications manager 620 may include a DMRS component 625, a control information component 630, an operations manager 635, a configuration component 640, a mapping component 645, an aggregation level component 650, a capability component 655, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The DMRS component 625 is capable of, configured to, or operable to support a means for receiving a set of DMRSs associated with a downlink control channel, where the set of DMRSs is received in accordance with one or more parameters, and where the one or more parameters are indicative of control information for the UE. The control information component 630 is capable of, configured to, or operable to support a means for identifying the control information that is indicated by the one or more parameters of the set of DMRSs. The operations manager 635 is capable of, configured to, or operable to support a means for performing one or more operations in accordance with the control information.

In some examples, the configuration component 640 is capable of, configured to, or operable to support a means for receiving one or more control messages indicating a configuration of one or more search space sets or one or more CORESETs, or any combination thereof, that use the set of DMRSs having the one or more parameters indicative of the control information, where receiving the set of DMRSs is in accordance with the configuration.

In some examples, the mapping component 645 is capable of, configured to, or operable to support a means for receiving an indication of a mapping between the one or more parameters and the control information, where the control information is identified in accordance with the mapping.

In some examples, the one or more parameters include a time-domain location of the set of DMRSs, and the aggregation level component 650 is capable of, configured to, or operable to support a means for determining a threshold aggregation level associated with the downlink control channel using the time-domain location of the set of DMRSs, where performing the one or more operations includes performing blind decoding for the downlink control channel in accordance with the threshold aggregation level.

In some examples, the one or more parameters include a density of the set of DMRSs across one or more symbol periods, and the aggregation level component 650 is capable of, configured to, or operable to support a means for determining a threshold aggregation level associated with the downlink control channel using the density of the set of DMRSs, where performing the one or more operations includes performing blind decoding for the downlink control channel in accordance with the threshold aggregation level.

In some examples, the capability component 655 is capable of, configured to, or operable to support a means for transmitting a capability message indicating that the UE supports the one or more operations, where receiving the set of DMRSs having the one or more parameters indicative of the control information is in accordance with the capability message.

In some examples, the one or more parameters include a time-domain location of the set of DMRSs, a frequency-domain location of the set of DMRSs, a comb offset of the set of DMRSs, a frequency-domain density of the set of DMRSs, or any combination thereof.

In some examples, the control information includes a physical downlink control channel skipping indication, a search space set group switching indication, an indication of a threshold quantity of blind decoding attempts, a blind decoding priority, a monitoring periodicity associated with a search space set, a quantity of monitoring occasions associated with a search space set, a size of a CORESET, a threshold aggregation level associated with the downlink control channel, or any combination thereof.

In some examples, the one or more parameters include a power offset corresponding to the set of DMRSs. In some examples, the power offset is associated with an aggregation level of the downlink control channel.

In some examples, the one or more parameters include a location associated with the set of DMRSs or a pattern associated with the set of DMRSs, or both. In some examples, the control information indicates a power offset corresponding to the set of DMRSs. In some examples, the power offset is relative to one or more other reference signals.

In some examples, to support performing the one or more operations, the operations manager 635 is capable of, configured to, or operable to support a means for powering up one or more radio components of the UE in accordance with the control information, where the control information includes an indication to power up the one or more radio components.

In some examples, to support performing the one or more operations, the operations manager 635 is capable of, configured to, or operable to support a means for monitoring for the downlink control channel using a physical downlink control channel monitoring scheme, where the control information includes an indication of the physical downlink control channel monitoring scheme.

In some examples, a threshold quantity of non-overlapping control channel elements associated with the downlink control channel is in accordance with the set of DMRSs having the one or more parameters indicative of the control information.

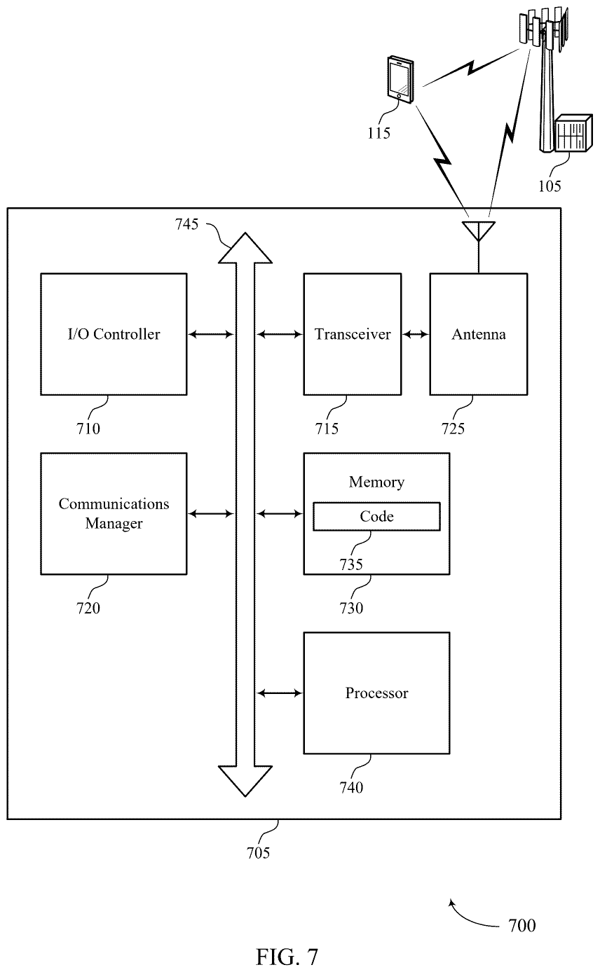

FIG. 7 shows a diagram of a system 700 including a device 705 that supports DMRS-based control information signaling in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting DMRS-based control information signaling). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving a set of DMRSs associated with a downlink control channel, where the set of DMRSs is received in accordance with one or more parameters, and where the one or more parameters are indicative of control information for the UE. The communications manager 720 is capable of, configured to, or operable to support a means for identifying the control information that is indicated by the one or more parameters of the set of DMRSs. The communications manager 720 is capable of, configured to, or operable to support a means for performing one or more operations in accordance with the control information.

By including or configuring the communications manager 720 in accordance with examples as described herein, the device 705 may support techniques for reduced latency, improved user experience related to reduced processing, reduced power consumption, more efficient utilization of communication resources, improved coordination between devices, longer battery life, and improved utilization of processing capability, among other examples. In some aspects, the control information (e.g., side information) indicated via DMRS parameters may enhance the device's ability to detect and identify control information intended for the device 705. As such, communications efficiency and power consumption may be improved.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of DMRS-based control information signaling as described herein, or the at least one processor 740 and the at least one memory 730 may be otherwise configured to, individually or collectively, perform or support such operations.

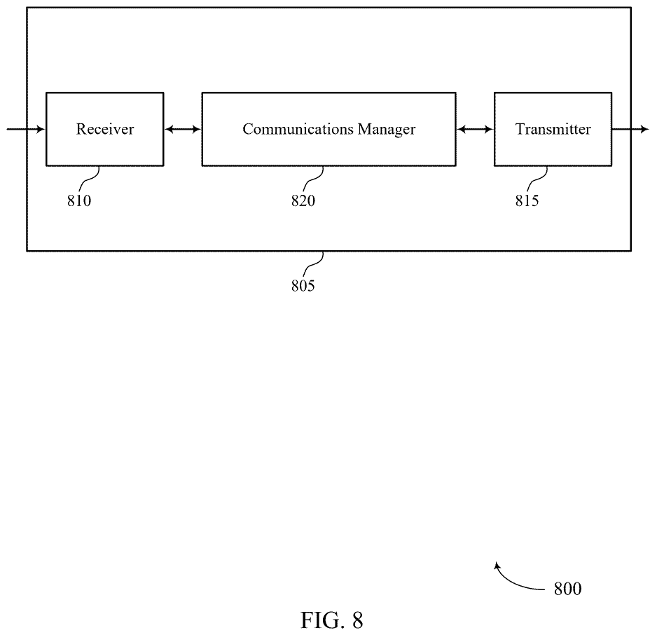

FIG. 8 shows a block diagram 800 of a device 805 that supports DMRS-based control information signaling in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of DMRS-based control information signaling as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for configuring, for a set of DMRSs, one or more parameters that are indicative of control information associated with one or more operations to be performed by a UE. The communications manager 820 is capable of, configured to, or operable to support a means for outputting the set of DMRSs in association with a downlink control channel, where the set of DMRSs are output in accordance with the one or more parameters.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, more efficient utilization of communication resources, among other examples. For instance, by indicating some control information using DMRS parameters (e.g., offloading some control information to DMRS parameters), a UE may identify the control information provided by the device 805 prior to decoding DCI. As such, the UE may be provided with an “early” indication of such control information, enabling more efficient utilization of communications resources.

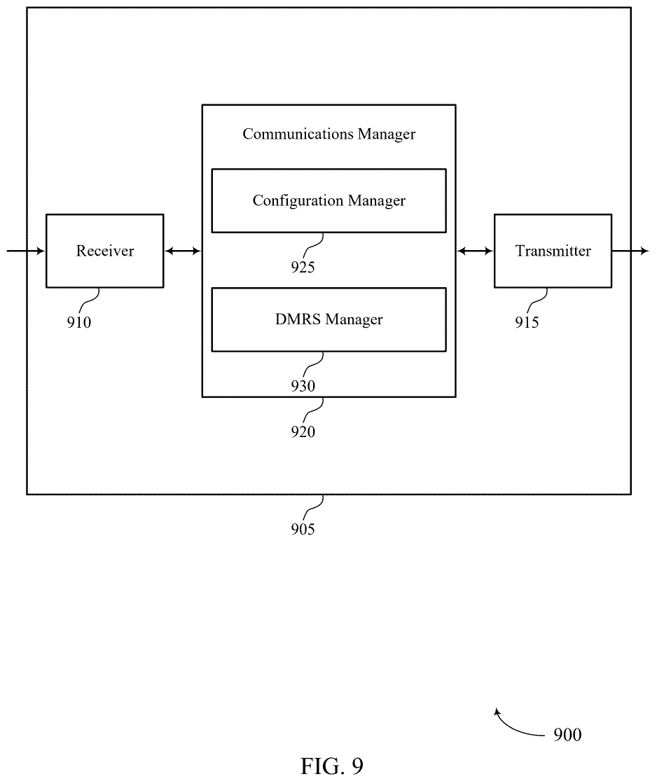

FIG. 9 shows a block diagram 900 of a device 905 that supports DMRS-based control information signaling in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of DMRS-based control information signaling as described herein. For example, the communications manager 920 may include a configuration manager 925 a DMRS manager 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The configuration manager 925 is capable of, configured to, or operable to support a means for configuring, for a set of DMRSs, one or more parameters that are indicative of control information associated with one or more operations to be performed by a UE. The DMRS manager 930 is capable of, configured to, or operable to support a means for outputting the set of DMRSs in association with a downlink control channel, where the set of DMRSs are output in accordance with the one or more parameters.

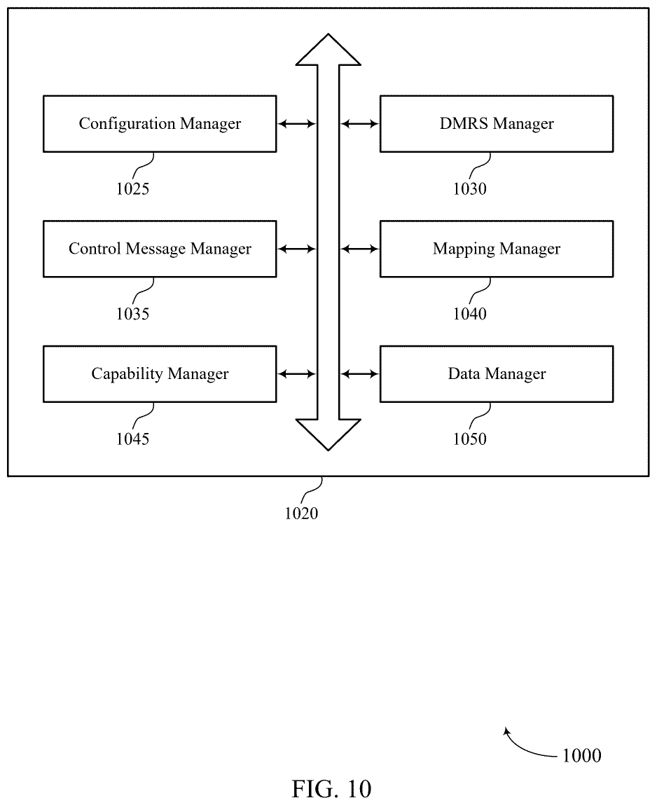

FIG. 10 shows a block diagram 1000 of a communications manager 1020 that supports DMRS-based control information signaling in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of DMRS-based control information signaling as described herein. For example, the communications manager 1020 may include a configuration manager 1025, a DMRS manager 1030, a control message manager 1035, a mapping manager 1040, a capability manager 1045, a data manager 1050, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The configuration manager 1025 is capable of, configured to, or operable to support a means for configuring, for a set of DMRSs, one or more parameters that are indicative of control information associated with one or more operations to be performed by a UE. The DMRS manager 1030 is capable of, configured to, or operable to support a means for outputting the set of DMRSs in association with a downlink control channel, where the set of DMRSs are output in accordance with the one or more parameters.

In some examples, the control message manager 1035 is capable of, configured to, or operable to support a means for outputting one or more control messages indicating a configuration of one or more search space sets or one or more CORESETs, or any combination thereof, that use the set of DMRSs having the one or more parameters indicative of the control information, where outputting the set of DMRSs is in accordance with the configuration.

In some examples, the mapping manager 1040 is capable of, configured to, or operable to support a means for outputting an indication of a mapping between the one or more parameters and the control information, where the one or more parameters are indicative of the control information in accordance with the mapping.

In some examples, the one or more parameters include a time-domain location of the set of DMRSs. In some examples, a threshold aggregation level associated with the downlink control channel corresponds to the time-domain location of the set of DMRSs.

In some examples, the one or more parameters include a density of the set of DMRSs across one or more symbol periods. In some examples, a threshold aggregation level associated with the downlink control channel corresponds to the density of the set of DMRSs.

In some examples, the capability manager 1045 is capable of, configured to, or operable to support a means for obtaining a capability message indicating that the UE supports the one or more operations, where outputting the set of DMRSs having the one or more parameters indicative of the control information is in accordance with the capability message.

In some examples, the one or more parameters include a time-domain location of the set of DMRSs, a frequency-domain location of the set of DMRSs, a comb offset of the set of DMRSs, a frequency-domain density of the set of DMRSs, or any combination thereof.

In some examples, the control information includes a physical downlink control channel skipping indication, a search space set group switching indication, an indication of a threshold quantity of blind decoding attempts, a blind decoding priority, a monitoring periodicity associated with a search space set, a quantity of monitoring occasions associated with a search space set, a size of a CORESET, a threshold aggregation level associated with the downlink control channel, or any combination thereof.

In some examples, the one or more parameters include a power offset corresponding to the set of DMRSs. In some examples, the power offset is associated with an aggregation level of the downlink control channel.

In some examples, the one or more parameters include a location associated with the set of DMRSs or a pattern associated with the set of DMRSs, or both. In some examples, the control information indicates a power offset corresponding to the set of DMRSs. In some examples, the power offset is relative to one or more other reference signals.

In some examples, the data manager 1050 is capable of, configured to, or operable to support a means for identifying data that is available for communications with the UE, where the control information includes an indication for the UE to power up one or more radio components to receive the identified data.

In some examples, the control information includes an indication of a physical downlink control channel monitoring scheme.

In some examples, a threshold quantity of non-overlapping control channel elements associated with the downlink control channel is in accordance with the set of DMRSs having the one or more parameters indicative of the control information.

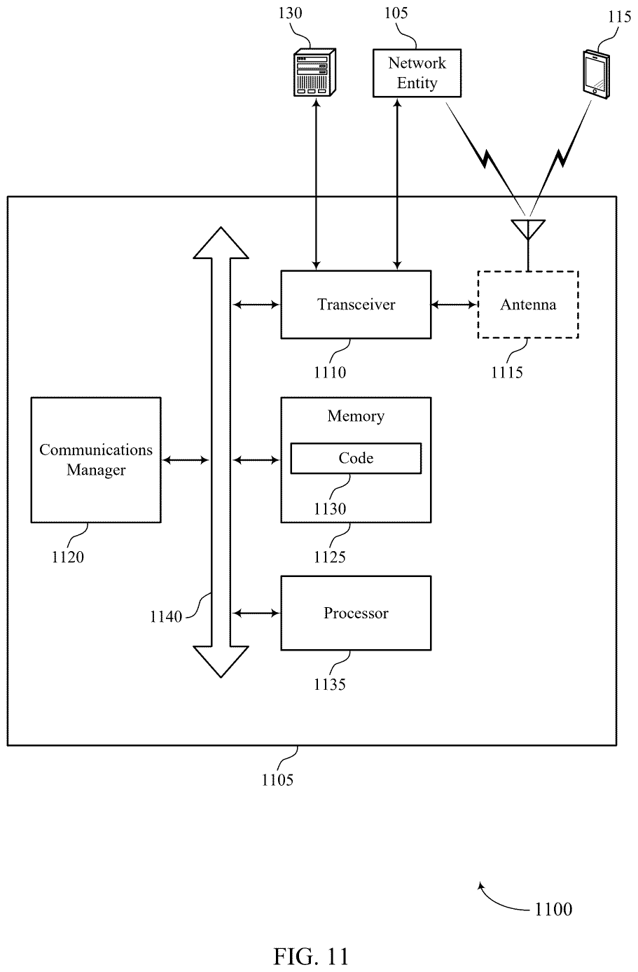

FIG. 11 shows a diagram of a system 1100 including a device 1105 that supports DMRS-based control information signaling in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications via one or more wired interfaces, via one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting DMRS-based control information signaling). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for configuring, for a set of DMRSs, one or more parameters that are indicative of control information associated with one or more operations to be performed by a UE. The communications manager 1120 is capable of, configured to, or operable to support a means for outputting the set of DMRSs in association with a downlink control channel, where the set of DMRSs are output in accordance with the one or more parameters.

By including or configuring the communications manager 1120 in accordance with examples as described herein, the device 1105 may support techniques for reduced latency, improved user experience related to reduced processing, reduced power consumption, more efficient utilization of communication resources, improved coordination between devices, longer battery life, and improved utilization of processing capability, among other examples. In some aspects, the control information (e.g., side information) indicated via the DMRS parameters may enhance a receiving device's ability to detect and identify control information. As such, communications efficiency and power consumption may be improved.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of DMRS-based control information signaling as described herein, or the at least one processor 1135 and the at least one memory 1125 may be otherwise configured to, individually or collectively, perform or support such operations.

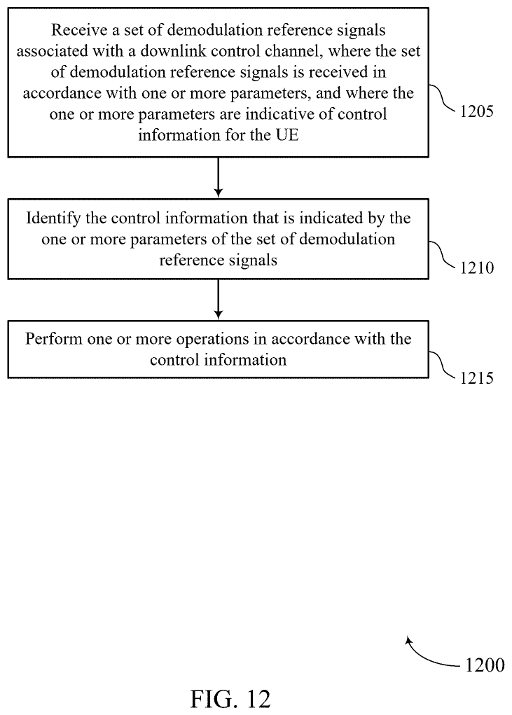

FIG. 12 shows a flowchart illustrating a method 1200 that supports DMRS-based control information signaling in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving a set of DMRSs associated with a downlink control channel, where the set of DMRSs is received in accordance with one or more parameters, and where the one or more parameters are indicative of control information for the UE. The operations of 1205 may be performed in accordance with examples as disclosed herein. In some examples, aspects of the operations of 1205 may be performed by a DMRS component 625 as described with reference to FIG. 6.

At 1210, the method may include identifying the control information that is indicated by the one or more parameters of the set of DMRSs. The operations of 1210 may be performed in accordance with examples as disclosed herein. In some examples, aspects of the operations of 1210 may be performed by a control information component 630 as described with reference to FIG. 6.

At 1215, the method may include performing one or more operations in accordance with the control information. The operations of 1215 may be performed in accordance with examples as disclosed herein. In some examples, aspects of the operations of 1215 may be performed by an operations manager 635 as described with reference to FIG. 6.

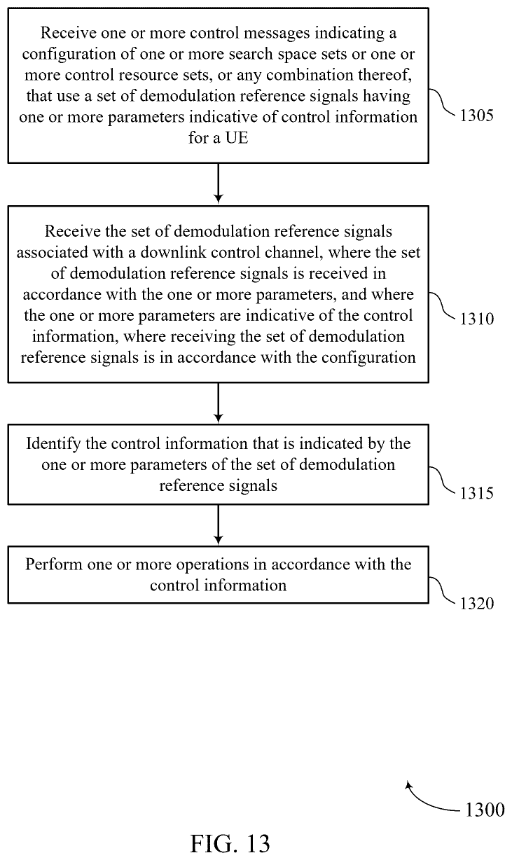

FIG. 13 shows a flowchart illustrating a method 1300 that supports DMRS-based control information signaling in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving one or more control messages indicating a configuration of one or more search space sets or one or more CORESETs, or any combination thereof, that use a set of DMRSs having one or more parameters indicative of control information. The operations of 1305 may be performed in accordance with examples as disclosed herein. In some examples, aspects of the operations of 1305 may be performed by a configuration component 640 as described with reference to FIG. 6.

At 1310, the method may include receiving a set of DMRSs associated with a downlink control channel (e.g., a PDCCH), where the set of DMRSs is received in accordance with the one or more parameters, and where the one or more parameters are indicative of the control information. In some examples, receiving the set of DMRSs is in accordance with the configuration. The operations of 1310 may be performed in accordance with examples as disclosed herein. In some examples, aspects of the operations of 1310 may be performed by a DMRS component 625 as described with reference to FIG. 6.

At 1315, the method may include identifying the control information that is indicated by the one or more parameters of the set of DMRSs. The operations of 1315 may be performed in accordance with examples as disclosed herein. In some examples, aspects of the operations of 1315 may be performed by a control information component 630 as described with reference to FIG. 6.

At 1320, the method may include performing one or more operations in accordance with the control information. The operations of 1320 may be performed in accordance with examples as disclosed herein. In some examples, aspects of the operations of 1320 may be performed by an operations manager 635 as described with reference to FIG. 6.

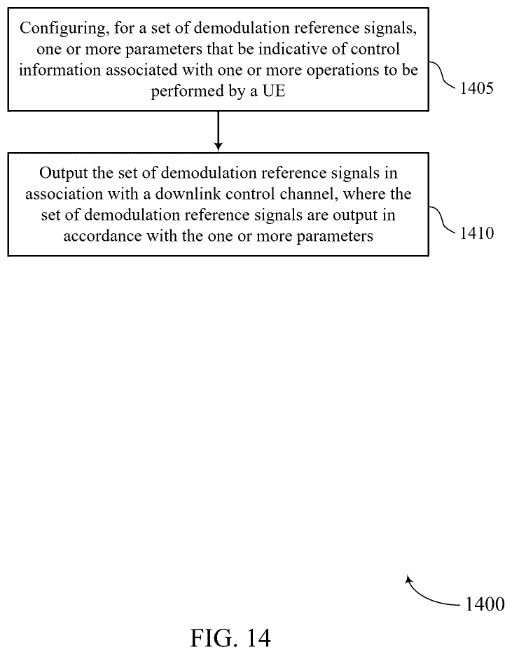

FIG. 14 shows a flowchart illustrating a method 1400 that supports DMRS-based control information signaling in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include configuring, for a set of DMRSs, one or more parameters that are indicative of control information associated with one or more operations to be performed by a UE. The operations of 1405 may be performed in accordance with examples as disclosed herein. In some examples, aspects of the operations of 1405 may be performed by a configuration manager 1025 as described with reference to FIG. 10.

At 1410, the method may include outputting the set of DMRSs in association with a downlink control channel, where the set of DMRSs are output in accordance with the one or more parameters. The operations of 1410 may be performed in accordance with examples as disclosed herein. In some examples, aspects of the operations of 1410 may be performed by a DMRS manager 1030 as described with reference to FIG. 10.

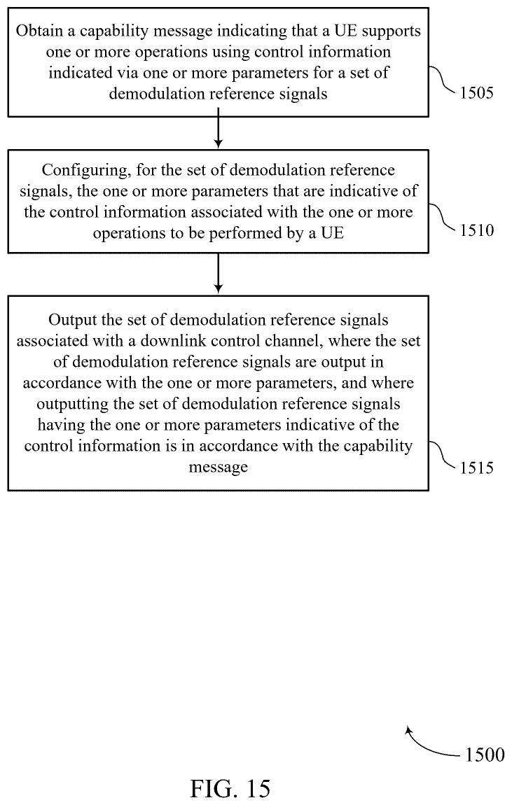

FIG. 15 shows a flowchart illustrating a method 1500 that supports DMRS-based control information signaling in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include obtaining a capability message indicating that a UE supports one or more operations using control information indicated via one or more parameters for a set of DMRSs. The operations of 1505 may be performed in accordance with examples as disclosed herein. In some examples, aspects of the operations of 1505 may be performed by a capability manager 1045 as described with reference to FIG. 10.

At 1510, the method may include configuring, for the set of DMRSs, the one or more parameters that are indicative of the control information associated with the one or more operations to be performed by a UE. The operations of 1510 may be performed in accordance with examples as disclosed herein. In some examples, aspects of the operations of 1510 may be performed by a configuration manager 1025 as described with reference to FIG. 10.

At 1515, the method may include outputting the set of DMRSs in association with a downlink control channel, where the set of DMRSs are output in accordance with the one or more parameters. In some examples, outputting the set of DMRSs having the one or more parameters indicative of the control information is in accordance with the capability message. The operations of 1515 may be performed in accordance with examples as disclosed herein. In some examples, aspects of the operations of 1515 may be performed by a DMRS manager 1030 as described with reference to FIG. 10.

The following provides an overview of aspects of the present disclosure:

Aspect 1: A method for wireless communications at a UE, comprising: receiving a set of demodulation reference signals associated with a downlink control channel, wherein the set of demodulation reference signals is received in accordance with one or more parameters, and wherein the one or more parameters are indicative of control information for the UE; identifying the control information that is indicated by the one or more parameters of the set of demodulation reference signals; and performing one or more operations in accordance with the control information.

Aspect 2: The method of aspect 1, further comprising: receiving one or more control messages indicating a configuration of one or more search space sets or one or more control resource sets, or any combination thereof, that use the set of demodulation reference signals having the one or more parameters indicative of the control information, wherein receiving the set of demodulation reference signals is in accordance with the configuration.

Aspect 3: The method of any of aspects 1 through 2, further comprising: receiving an indication of a mapping between the one or more parameters and the control information, wherein the control information is identified in accordance with the mapping.

Aspect 4: The method of any of aspects 1 through 3, wherein the one or more parameters comprise a time-domain location of the set of demodulation reference signals, the method further comprising: determining a threshold aggregation level associated with the downlink control channel using the time-domain location of the set of demodulation reference signals, wherein performing the one or more operations comprises performing blind decoding for the downlink control channel in accordance with the threshold aggregation level.

Aspect 5: The method of any of aspects 1 through 4, wherein the one or more parameters comprise a density of the set of demodulation reference signals across one or more symbol periods, the method further comprising: determining a threshold aggregation level associated with the downlink control channel using the density of the set of demodulation reference signals, wherein performing the one or more operations comprises performing blind decoding for the downlink control channel in accordance with the threshold aggregation level.

Aspect 6: The method of any of aspects 1 through 5, further comprising: transmitting a capability message indicating that the UE supports the one or more operations, wherein receiving the set of demodulation reference signals having the one or more parameters indicative of the control information is in accordance with the capability message.

Aspect 7: The method of any of aspects 1 through 6, wherein the one or more parameters comprise a time-domain location of the set of demodulation reference signals, a frequency-domain location of the set of demodulation reference signals, a comb offset of the set of demodulation reference signals, a frequency-domain density of the set of demodulation reference signals, or any combination thereof.

Aspect 8: The method of any of aspects 1 through 7, wherein the control information comprises a physical downlink control channel skipping indication, a search space set group switching indication, an indication of a threshold quantity of blind decoding attempts, a blind decoding priority, a monitoring periodicity associated with a search space set, a quantity of monitoring occasions associated with a search space set, a size of a control resource set, a threshold aggregation level associated with the downlink control channel, or any combination thereof.

Aspect 9: The method of any of aspects 1 through 8, wherein the one or more parameters comprise a power offset corresponding to the set of demodulation reference signals, and the power offset is associated with an aggregation level of the downlink control channel.

Aspect 10: The method of any of aspects 1 through 9, wherein the one or more parameters comprise a location associated with the set of demodulation reference signals or a pattern associated with the set of demodulation reference signals, or both, the control information indicates a power offset corresponding to the set of demodulation reference signals, and the power offset is relative to one or more other reference signals.

Aspect 11: The method of any of aspects 1 through 10, wherein performing the one or more operations comprises: powering up one or more radio components of the UE in accordance with the control information, wherein the control information comprises an indication to power up the one or more radio components.

Aspect 12: The method of any of aspects 1 through 11, wherein performing the one or more operations comprises: monitoring for the downlink control channel using a physical downlink control channel monitoring scheme, wherein the control information comprises an indication of the physical downlink control channel monitoring scheme.

Aspect 13: The method of any of aspects 1 through 12, wherein a threshold quantity of non-overlapping control channel elements associated with the downlink control channel is in accordance with the set of demodulation reference signals having the one or more parameters indicative of the control information.

Aspect 14: A method for wireless communications at a network entity, comprising: configuring, for a set of demodulation reference signals, one or more parameters that are indicative of control information associated with one or more operations to be performed by a UE; and outputting the set of demodulation reference signals in association with a downlink control channel, wherein the set of demodulation reference signals are output in accordance with the one or more parameters.

Aspect 15: The method of aspect 14, further comprising: outputting one or more control messages indicating a configuration of one or more search space sets or one or more control resource sets, or any combination thereof, that use the set of demodulation reference signals having the one or more parameters indicative of the control information, wherein outputting the set of demodulation reference signals is in accordance with the configuration.

Aspect 16: The method of any of aspects 14 through 15, further comprising: outputting an indication of a mapping between the one or more parameters and the control information, wherein the one or more parameters are indicative of the control information in accordance with the mapping.

Aspect 17: The method of any of aspects 14 through 16, wherein the one or more parameters comprise a time-domain location of the set of demodulation reference signals, and a threshold aggregation level associated with the downlink control channel corresponds to the time-domain location of the set of demodulation reference signals.

Aspect 18: The method of any of aspects 14 through 17, wherein the one or more parameters comprise a density of the set of demodulation reference signals across one or more symbol periods, and a threshold aggregation level associated with the downlink control channel corresponds to the density of the set of demodulation reference signals.

Aspect 19: The method of any of aspects 14 through 18, further comprising: obtaining a capability message indicating that the UE supports the one or more operations, wherein outputting the set of demodulation reference signals having the one or more parameters indicative of the control information is in accordance with the capability message.

Aspect 20: The method of any of aspects 14 through 19, wherein the one or more parameters comprise a time-domain location of the set of demodulation reference signals, a frequency-domain location of the set of demodulation reference signals, a comb offset of the set of demodulation reference signals, a frequency-domain density of the set of demodulation reference signals, or any combination thereof.

Aspect 21: The method of any of aspects 14 through 20, wherein the control information comprises a physical downlink control channel skipping indication, a search space set group switching indication, an indication of a threshold quantity of blind decoding attempts, a blind decoding priority, a monitoring periodicity associated with a search space set, a quantity of monitoring occasions associated with a search space set, a size of a control resource set, a threshold aggregation level associated with the downlink control channel, or any combination thereof.

Aspect 22: The method of any of aspects 14 through 21, wherein the one or more parameters comprise a power offset corresponding to the set of demodulation reference signals, and the power offset is associated with an aggregation level of the downlink control channel.

Aspect 23: The method of any of aspects 14 through 22, wherein the one or more parameters comprise a location associated with the set of demodulation reference signals or a pattern associated with the set of demodulation reference signals, or both, the control information indicates a power offset corresponding to the set of demodulation reference signals, and the power offset is relative to one or more other reference signals.

Aspect 24: The method of any of aspects 14 through 23, further comprising: identifying data that is available for communications with the UE, wherein the control information comprises an indication for the UE to power up one or more radio components to receive the identified data.

Aspect 25: The method of any of aspects 14 through 24, wherein the control information comprises an indication of a physical downlink control channel monitoring scheme.

Aspect 26: The method of any of aspects 14 through 25, wherein a threshold quantity of non-overlapping control channel elements associated with the downlink control channel is in accordance with the set of demodulation reference signals having the one or more parameters indicative of the control information.

Aspect 27: A UE for wireless communications, comprising one or more memories storing processor-executable code, and one or more processors coupled with the one or more memories and individually or collectively operable to execute the code to cause the UE to perform a method of any of aspects 1 through 13.

Aspect 28: A UE for wireless communications, comprising at least one means for performing a method of any of aspects 1 through 13.

Aspect 29: A non-transitory computer-readable medium storing code for wireless communications, the code comprising instructions executable by one or more processors to perform a method of any of aspects 1 through 13.

Aspect 30: A network entity for wireless communications, comprising one or more memories storing processor-executable code, and one or more processors coupled with the one or more memories and individually or collectively operable to execute the code to cause the network entity to perform a method of any of aspects 14 through 26.

Aspect 31: A network entity for wireless communications, comprising at least one means for performing a method of any of aspects 14 through 26.

Aspect 32: A non-transitory computer-readable medium storing code for wireless communications, the code comprising instructions executable by one or more processors to perform a method of any of aspects 14 through 26.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.” Also, as used herein, the phrase “a set” shall be construed as including the possibility of a set with one member. That is, the phrase “a set” shall be construed in the same manner as “one or more.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a set of demodulation reference signals associated with a downlink control channel, wherein the set of demodulation reference signals is received in accordance with one or more parameters, and wherein the one or more parameters are indicative of control information for the UE;
identify the control information that is indicated by the one or more parameters of the set of demodulation reference signals; and
perform one or more operations in accordance with the control information.

2. The UE of claim 1, wherein the one or more processors are individually or collectively further operable to execute the code to cause the UE to:
receive one or more control messages indicating a configuration of one or more search space sets or one or more control resource sets, or any combination thereof, that use the set of demodulation reference signals having the one or more parameters indicative of the control information, wherein receiving the set of demodulation reference signals is in accordance with the configuration.

3. The UE of claim 1, wherein the one or more processors are individually or collectively further operable to execute the code to cause the UE to:
receive an indication of a mapping between the one or more parameters and the control information, wherein the control information is identified in accordance with the mapping.

4. The UE of claim 1, wherein the one or more parameters comprise a time-domain location of the set of demodulation reference signals, and the one or more processors are individually or collectively further operable to execute the code to cause the UE to:
determine a threshold aggregation level associated with the downlink control channel using the time-domain location of the set of demodulation reference signals, wherein performing the one or more operations comprises performing blind decoding for the downlink control channel in accordance with the threshold aggregation level.

5. The UE of claim 1, wherein the one or more parameters comprise a density of the set of demodulation reference signals across one or more symbol periods, and the one or more processors are individually or collectively further operable to execute the code to cause the UE to:
determine a threshold aggregation level associated with the downlink control channel using the density of the set of demodulation reference signals, wherein performing the one or more operations comprises performing blind decoding for the downlink control channel in accordance with the threshold aggregation level.

6. The UE of claim 1, wherein the one or more processors are individually or collectively further operable to execute the code to cause the UE to:
transmit a capability message indicating that the UE supports the one or more operations, wherein receiving the set of demodulation reference signals having the one or more parameters indicative of the control information is in accordance with the capability message.

7. The UE of claim 1, wherein the one or more parameters comprise a time-domain location of the set of demodulation reference signals, a frequency-domain location of the set of demodulation reference signals, a comb offset of the set of demodulation reference signals, a frequency-domain density of the set of demodulation reference signals, or any combination thereof.

8. The UE of claim 1, wherein the control information comprises a physical downlink control channel skipping indication, a search space set group switching indication, an indication of a threshold quantity of blind decoding attempts, a blind decoding priority, a monitoring periodicity associated with a search space set, a quantity of monitoring occasions associated with a search space set, a size of a control resource set, a threshold aggregation level associated with the downlink control channel, or any combination thereof.

9. The UE of claim 1, wherein the one or more parameters comprise a power offset corresponding to the set of demodulation reference signals, and wherein the power offset is associated with an aggregation level of the downlink control channel.

10. The UE of claim 1, wherein:
the one or more parameters comprise a location associated with the set of demodulation reference signals or a pattern associated with the set of demodulation reference signals, or both,
the control information indicates a power offset corresponding to the set of demodulation reference signals, and
the power offset is relative to one or more other reference signals.

11. The UE of claim 1, wherein, to perform the one or more operations, the one or more processors are individually or collectively operable to execute the code to cause the UE to:
power up one or more radio components of the UE in accordance with the control information, wherein the control information comprises an indication to power up the one or more radio components.

12. The UE of claim 1, wherein, to perform the one or more operations, the one or more processors are individually or collectively operable to execute the code to cause the UE to:
monitor for the downlink control channel using a physical downlink control channel monitoring scheme, wherein the control information comprises an indication of the physical downlink control channel monitoring scheme.

13. The UE of claim 1, wherein a threshold quantity of non-overlapping control channel elements associated with the downlink control channel is in accordance with the set of demodulation reference signals having the one or more parameters indicative of the control information.

14. A network entity, comprising:
one or more memories storing processor-executable code; and
one or more processors coupled with the one or more memories and individually or collectively operable to execute the code to cause the network entity to:
configuring, for a set of demodulation reference signals, one or more parameters that are indicative of control information associated with one or more operations to be performed by a user equipment (UE); and
output the set of demodulation reference signals in association with a downlink control channel, wherein the set of demodulation reference signals are output in accordance with the one or more parameters.

15. The network entity of claim 14, wherein the one or more processors are individually or collectively further operable to execute the code to cause the network entity to:
output one or more control messages indicating a configuration of one or more search space sets or one or more control resource sets, or any combination thereof, that use the set of demodulation reference signals having the one or more parameters indicative of the control information, wherein outputting the set of demodulation reference signals is in accordance with the configuration.

16. The network entity of claim 14, wherein the one or more processors are individually or collectively further operable to execute the code to cause the network entity to:
output an indication of a mapping between the one or more parameters and the control information, wherein the one or more parameters are indicative of the control information in accordance with the mapping.

17. The network entity of claim 14, wherein the one or more parameters comprise a time-domain location of the set of demodulation reference signals, and wherein a threshold aggregation level associated with the downlink control channel corresponds to the time-domain location of the set of demodulation reference signals.

18. The network entity of claim 14, wherein:
the one or more parameters comprise a density of the set of demodulation reference signals across one or more symbol periods, and
a threshold aggregation level associated with the downlink control channel corresponds to the density of the set of demodulation reference signals.

19. The network entity of claim 14, wherein the one or more processors are individually or collectively further operable to execute the code to cause the network entity to:
obtain a capability message indicating that the UE supports the one or more operations, wherein outputting the set of demodulation reference signals having the one or more parameters indicative of the control information is in accordance with the capability message.

20. The network entity of claim 14, wherein the one or more parameters comprise a time-domain location of the set of demodulation reference signals, a frequency-domain location of the set of demodulation reference signals, a comb offset of the set of demodulation reference signals, a frequency-domain density of the set of demodulation reference signals, or any combination thereof.

21. The network entity of claim 14, wherein the control information comprises a physical downlink control channel skipping indication, a search space set group switching indication, an indication of a threshold quantity of blind decoding attempts, a blind decoding priority, a monitoring periodicity associated with a search space set, a quantity of monitoring occasions associated with a search space set, a size of a control resource set, a threshold aggregation level associated with the downlink control channel, or any combination thereof.

22. The network entity of claim 14, wherein the one or more parameters comprise a power offset corresponding to the set of demodulation reference signals, and wherein the power offset is associated with an aggregation level of the downlink control channel.

23. The network entity of claim 14, wherein:
the one or more parameters comprise a location associated with the set of demodulation reference signals or a pattern associated with the set of demodulation reference signals, or both,
the control information indicates a power offset corresponding to the set of demodulation reference signals, and
the power offset is relative to one or more other reference signals.

24. The network entity of claim 14, wherein the one or more processors are individually or collectively further operable to execute the code to cause the network entity to:
identify data that is available for communications with the UE, wherein the control information comprises an indication for the UE to power up one or more radio components to receive the identified data.

25. The network entity of claim 14, wherein the control information comprises an indication of a physical downlink control channel monitoring scheme.

26. The network entity of claim 14, wherein a threshold quantity of non-overlapping control channel elements associated with the downlink control channel is in accordance with the set of demodulation reference signals having the one or more parameters indicative of the control information.

27. A method for wireless communications at a user equipment (UE), comprising:
receiving a set of demodulation reference signals associated with a downlink control channel, wherein the set of demodulation reference signals is received in accordance with one or more parameters, and wherein the one or more parameters are indicative of control information for the UE;
identifying the control information that is indicated by the one or more parameters of the set of demodulation reference signals; and
performing one or more operations in accordance with the control information.

28. The method of claim 27, further comprising:
receiving one or more control messages indicating a configuration of one or more search space sets or one or more control resource sets, or any combination thereof, that use the set of demodulation reference signals having the one or more parameters indicative of the control information, wherein receiving the set of demodulation reference signals is in accordance with the configuration.

29. A method for wireless communications at a network entity, comprising:
configuring, for a set of demodulation reference signals, one or more parameters that are indicative of control information associated with one or more operations to be performed by a user equipment (UE); and
outputting the set of demodulation reference signals in association with a downlink control channel, wherein the set of demodulation reference signals are output in accordance with the one or more parameters.

30. The method of claim 29, further comprising:
outputting one or more control messages indicating a configuration of one or more search space sets or one or more control resource sets, or any combination thereof, that use the set of demodulation reference signals having the one or more parameters indicative of the control information, wherein outputting the set of demodulation reference signals is in accordance with the configuration.
